(19) United States
(12) Patent Application Publication
(10) Pub. No.: US 2026/0279783 A1
(43) Pub. Date: Sep. 17, 2026

(54) Disordered Bi-Element Substitution for Cathode Materials

(71) Applicant: Nissan North America, Inc., Franklin, TN (US)

(72) Inventors: Simran Kumari, Santa Clara, CA (US); Albert Wang Xiao, Yokohama (JP); Masanobu Uchimura, Palo Alto, CA (US); Balachandran Gadaguntla Radhakrishnan, San Jose, CA (US); Shigemasa Kuwata, Palo Alto, CA (US)

(21) Appl. No.: 19/081,332

(22) Filed: Mar. 17, 2025

(51) Int. Cl. H01M 4/505; C01G 45/1214; H01M 4/02; H01M 10/0525

(52) U.S. Cl. CPC H01M 4/505; C01G 45/1214; H01M 10/0525; C01P 2002/32; C01P 2002/72; C01P 2006/40; H01M 2004/028

(57) ABSTRACT

A cathode material for an electrochemical cell has a cation disordered composition comprising a spinel crystal structure and a formula:

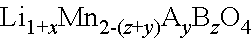

wherein 0.0≤x≤0.25, 0.01≤y≤0.49, 0.01≤z≤0.49, 0.02≤y+z≤0.5, and A and B are different and independently selected from Y, Zr, Si, V, Nb, Fe, Cu, Ti, and Al.

### TECHNICAL FIELD

This disclosure relates to bi-element substitution in lithium manganese oxide materials having a disordered spinel crystal structure.

### BACKGROUND

In the current state of batteries, alternatives to nickel and cobalt in cathodes are continually being investigated to determine if more cost effective and widely available materials can achieve desirable output and cycle properties. In addition, materials are being tested and identified that have sufficient charging capacity, charging speed, and that are useable with current battery chemistry schemes. Lithium manganese oxide (LMO) cathode materials have been identified as a material with the potential to meet the above needs. However, common LMO cathode materials suffer from a sharp two-phase transition during voltage discharge that limits rate capability and mechanically stresses the cathode material. Accordingly, what is needed are LMO cathode materials that do not suffer from the two-phase transition and can meet total capacity, cycle capacity, and stability within targeted battery chemistries.

### SUMMARY

Disclosed herein are implementations of LMO cathode materials with bi-element substitution producing a controlled disordered spinel crystal structure that does not lead to structural collapse due to the transition to the rock salt phase.

In an implementation, a cathode material for an electrochemical cell has a cation disordered composition comprising a spinel crystal structure and a formula:

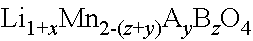

wherein 0.0≤x≤0.25, 0.01≤y≤0.49, 0.01≤z≤0.49, 0.02≤y+z≤0.5, and A and B are different and independently selected from Y, Zr, Si, V, Nb, Fe, Cu, Ti, and Al.

The cation disordered composition has a cell potential in a lithium-ion battery cell that exhibits a gradual voltage change, wherein a percentage of total capacity observed between 3.9 and 2.9 V vs. Li+/Li is at least 6%.

In some implementations, the cell potential in a lithium-ion battery cell exhibits a gradual voltage change, wherein a percentage of total capacity (mAh/g) observed between 3.9 V and 2.9 V vs. Li+/Li is at least 8%.

In some implementations, the cell potential in a lithium-ion battery cell exhibits a gradual voltage change, wherein a percentage of total capacity (mAh/g) observed between 3.9 V and 2.9 V vs. Li+/Li is at least 9%.

Also disclosed are electrochemical cells having the cathode materials disclosed herein. The electrochemical cell may be a lithium-ion battery cell or a lithium metal battery cell. The cathode material facilitates lithium-ion intercalation and deintercalation through a disordered spinel structure in the cells.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 illustrates a graph of cell potential compared to capacity during cycling of cell charge and discharge of a LiMn₂O₄ cathode material.

FIG. 2 illustrates a graph of cell potential compared to capacity during cycling of cell charge and discharge of a LiMn_{1.75}Y_{0.125}Zr_{0.125}O₄ cathode material.

FIG. 3 illustrates a graph of cell potential compared to capacity during cycling of cell charge and discharge of a LiMn_{1.75}Zr_{0.125}Nb_{0.125}O₄ cathode material.

FIG. 4 illustrates a graph of cell potential compared to capacity during cycling of cell charge and discharge of a Li_{1.2}Mn_{1.75}Y_{0.125}Si_{0.125}O₄ cathode material.

FIG. 5 illustrates a graph of cell potential compared to capacity during cycling of cell charge and discharge of a Li_{1.2}Mn_{1.75}Zr_{0.125}Si_{0.125}O₄ cathode material.

FIG. 6 illustrates a graph of cell potential compared to capacity during cycling of cell charge and discharge of a Li_{1.2}Mn_{1.75}Y_{0.125}Nb_{0.125}O₄ cathode material.

FIG. 7 illustrates a graph of cell potential compared to capacity during cycling of cell charge and discharge of a Li_{1.2}Mn_{1.75}Si_{0.125}Nb_{0.125}O₄ cathode material.

FIG. 8 illustrates a graph of energy above hull for different bi-element substitutions of metals in the lithium manganese oxide cathode materials.

FIG. 9 is a cross-section schematic view of an electrochemical cell as disclosed herein.

FIG. 10 illustrates a X-Ray Diffraction data for different bi-element substitutions of elements in the lithium manganese oxide cathode materials.

### DETAILED DESCRIPTION

Lithium manganese oxide (LMO) cathode materials have been identified as a material with the potential to replace more conventional cathode materials such as nickel and cobalt, providing a more cost effective and more available material. The spinel phase (LiMn₂O₄) provides better electrochemical performance than other phases. However, traditional LMO structures tend to undergo a two-phase transition (spinel to rock-salt MnO-like phase) during cycling, which limits rate capability and causes mechanical stress. It has been found that controlled cation disorder in LMO, achieved through bi-element substitution, stabilizes the spinel structure and suppresses this transition, leading to enhanced electrochemical performance.

Disclosed herein are cathode materials for an electrochemical cell. The cathode materials have a cation disordered composition comprising a spinel crystal structure and a formula:

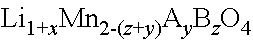

wherein 0.0≤x≤0.25, 0.01≤y≤0.49, 0.01≤z≤0.49, 0.02≤y+z≤0.5, and A and B are different and independently selected from Y, Zr, Si, V, Nb, Fe, Cu, Ti, and Al.

The displacement of the Mn between positions is stabilized through the introduction of two specific elements during chemical substitution (e.g., chemical decomposition). Metals, such as vanadium (V), copper (Cu), yttrium (Y), zirconium (Zr), niobium (Nb), iron (Fe), titanium (Ti), aluminum (Al) and silicon (Si) in any combination of two are introduced into spinel crystal structure and create disorder in the crystal structure by displacing Mn ions. The increased disorder allows for a sloping characteristic in the voltage vs. capacity curve during cell cycling and a gradual shift between the voltage plateaus in addition to improved capacity features. By avoiding a sharp two-phase shift during cycling, mechanical stress and capacity fade is reduced in the cathode material.

The cathode material may provide lithium battery cells with discharge capacities greater than 160 mAh/g, or greater than 170 mAh/g, or greater than 180 mAh/g, or greater than 190 mAh/g. The cathode material may provide lithium battery cells that operate between 4.5 V or 3.9 V to 2.9 V or 1.5 V. The cathode material exhibits a gradual voltage change without a plateau, such that at least 6%, 8%, or 9% of total capacity is delivered between 3.9 V and 2.9 V vs. Li+/Li, depending on the specific composition. This behavior contrasts with conventional LiMn2O4, which has a sharp plateau and only ~4% capacity in this range, as shown in FIG. 1, a constant current charge/discharge graph with a constant current of C/20.

As an example, in the cathode material disclosed herein, A is Y and B is Zr. The cathode material may have the following formula:

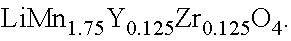

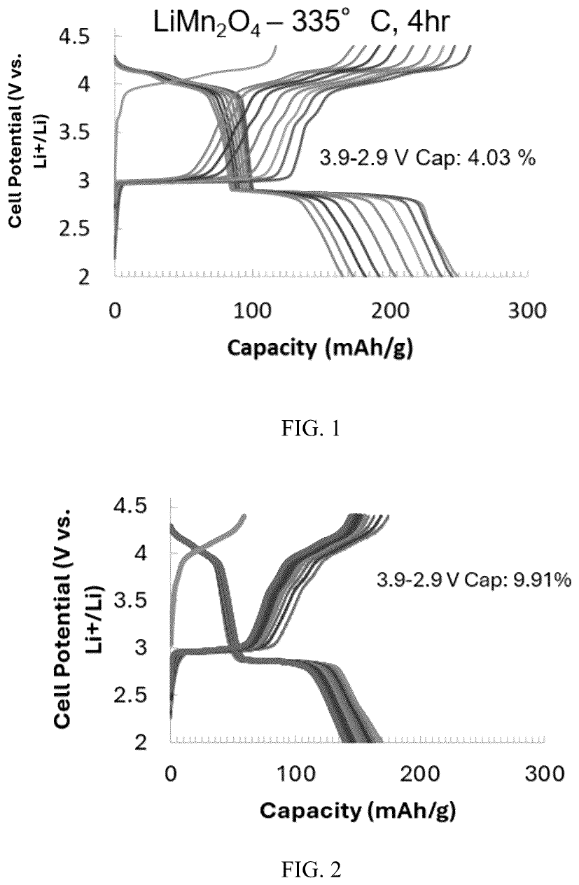

This cathode material has a cell potential in a lithium-ion battery cell that exhibits a gradual voltage change, wherein a percentage of total capacity (mAh/g) observed between 3.9 V and 2.9 V vs. Li+/Li is at least 9%. As shown in FIG. 2, this cathode material produces a transition capacity of 9.91% in the 3.9 V-2.9 V range. The discharge capacity is 168.71 mAh/g at a mid-point voltage of 3.061 V.

As another example, in the cathode material disclosed herein, A is Zr and B is Nb. The cathode material may have the following formula:

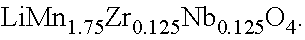

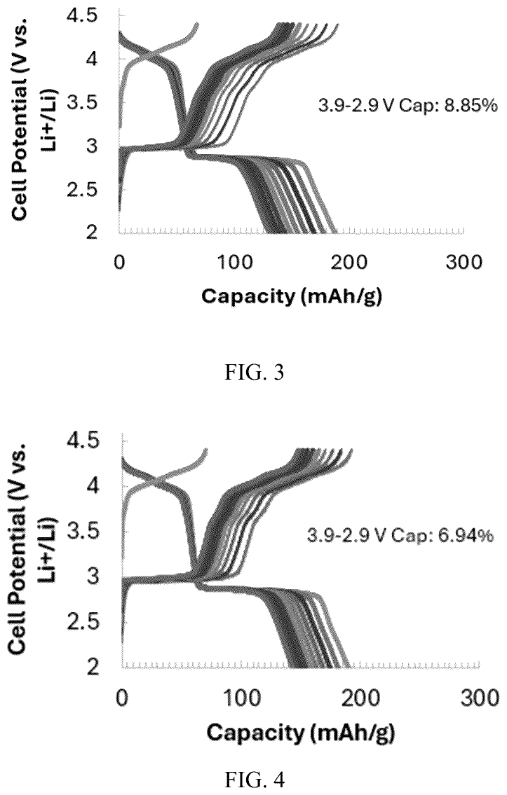

This cathode material has a cell potential in a lithium-ion battery cell that exhibits a gradual voltage change, wherein a percentage of total capacity (mAh/g) observed between 3.9 V and 2.9 V vs. Li+/Li is at least 8%. As shown in FIG. 3, this cathode material produces a transition capacity of 8.85% in the 3.9 V-2.9 V range. The discharge capacity is 187.94 mAh/g at a mid-point voltage of 3.150 V.

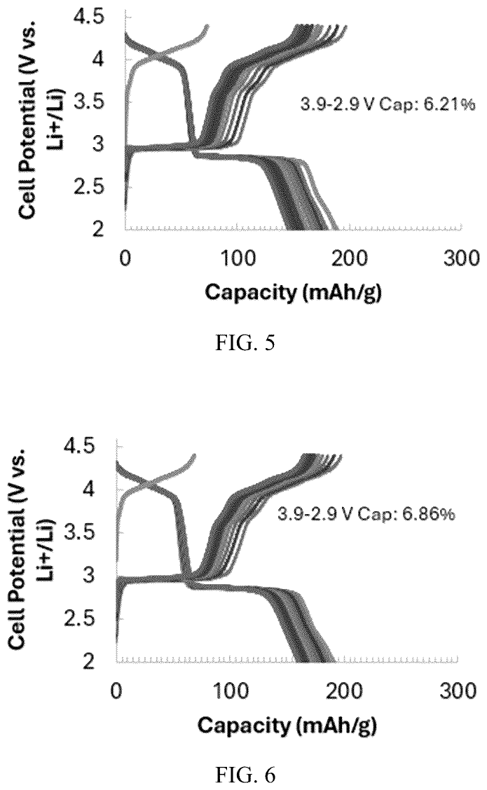

In other examples, in the cathode material disclosed herein, A may be one of Y or Zr and B may be Si. A cathode material having the formula Li_{1.2}Mn_{1.75}Y_{0.125}Si_{0.125}O₄ produces a transition capacity of 6.94% in the 3.9 V-2.9 V range. The discharge capacity is 190.16 mAh/g at a mid-point voltage of 3.171 V, as shown in FIG. 4. A cathode material having the formula Li_{1.2}Mn_{1.75}Zr_{0.125}Si_{0.125}O₄ produces a transition capacity of 6.21% in the 3.9 V-2.9 V range. The discharge capacity is 189.01 mAh/g at a mid-point voltage of 3.142 V, as shown in FIG. 5.

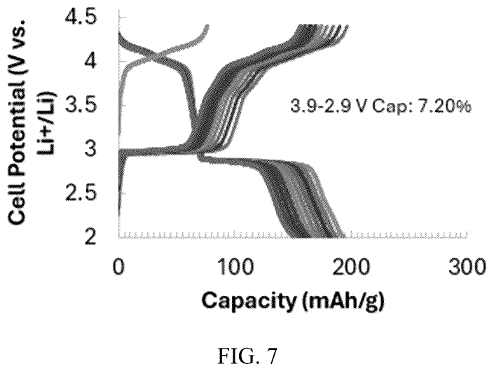

In yet other examples, A may be one of Y or Si and B may be Nb. The examples are non-limiting. A cathode material having the formula Li_{1.2}Mn_{1.75}Y_{0.125}Nb_{0.125}O₄ produces a transition capacity of 6.86% in the 3.9 V-2.9 V range. The discharge capacity is 191.25 mAh/g at a mid-point voltage of 3.131 V, as shown in FIG. 6. A cathode material having the formula Li_{1.2}Mn_{1.75}Si_{0.125}Nb_{0.125}O₄ produces a transition capacity of 7.20% in the 3.9 V-2.9 V range. The discharge capacity is 193.44 mAh/g at a mid-point voltage of 3.199 V, as shown in FIG. 7.

The disordered cathode material may be made from any starting components sufficient to achieve the spinel crystal structure of the substituted LMO. For example, one or more lithium precursors, manganese precursors, and substituted metal precursors may be mixed in appropriate stochiometric ratios to achieve the desired substituted LMO and/or lithiation. Lithium precursors may include one or more of lithium carbonate (Li₂CO₃), lithium nitrate (LiNO₃), lithium acetate (LiC₂H₃O₂), lithium hydroxide (LiOH), or combinations thereof. Manganese precursors may include one or more of manganese dioxide (MnO₂), manganese nitrate (Mn(NO₃)₂), manganese sulfate (MnSO4), manganese acetate (Mn(C₂H₃O₂)₂), manganese chloride (MnCl₂), manganese acetate ((CH₃CO₂)₂), or combinations thereof. Substitution metal precursors may include two of vanadium (V), copper (Cu), yttrium (Y), zirconium (Zr), niobium (Nb), iron (Fe), titanium (Ti), silicon (Si) and aluminum (Al) and one or more appropriate counterions. Appropriate counterions may include one or more oxides, acetates, nitrates, or any combination thereof. In some examples, the substitution metal precursor may be zirconium(IV) isopropoxide, niobium(V) ethoxide, aluminum isopropoxide, iron(III) nitrate, copper(II) acetate, yttrium(III) acetate, vanadium(V) oxytriisopropoxide, as non-limiting examples.

Mixing of the lithium precursors, manganese precursors, and substitution metal precursors may be conducted in an appropriate mixing solvent, gelling agent, or both. Mixing solvents may include one or more of water, ethanol, methanol, propanol, butanol, or any combination thereof. Gelling agents may include one or more chelating agents (e.g., citric acid or ethylene glycol). Solvents and/or gelling agents may be removed during a drying step to form a sol-gel precursor before chemical decomposition or other chemical substation techniques.

Disorder of the cathode material can be achieved through any means sufficient to displace at least some of the manganese in the spinel crystal structure. Displacement of manganese may move the manganese atoms from the 16d to the 16c position of the spinel crystal structure. As described throughout, disorder may be formed by displacement of the manganese from the 16d to the 16c positions and filling the voids in the 16d positions with substituted metal or silicon ions (other than manganese) and/or lithium ions. Disorder may be introduced by chemically altering, or optionally in combination with mechanically altering, the spinel crystal structure of the cathode material. In some examples, only chemical substitution is used to achieve disorder in the cathode material so that high mechanical stresses on the particles of the cathode material from mechanical altering, such as high energy ball milling, are avoided. Chemically altering the crystal structure may be achieved through decomposition of a sol-gel precursor, as described herein. Generally, mechanical altering may be conducted by high energy ball milling. In some examples, combinations of chemical and/or mechanical altering may be desired to achieve sufficient disorder to introduce the metal into the LMO crystal structure, which may reduce or eliminate the two-phase transition during cycling.

Chemically altering the crystal structure of the cathode material may be conducted such that desired metals are substituted into the crystal structure and displace some of the Mn ions from 16d to 16c positions in the crystal structure. Chemical altering may include mixing starting components into a substantially homogenous mixture or solution of starting components and appropriate solvents and drying the homogenous mixture or solution under vacuum and/or elevated temperature to remove solvents and to form a sol-gel precursor. Then, the sol-gel precursor is ground, and heat is applied to the ground sol-gel precursor to yield the substituted LMO. When heating the sol-gel precursor, the heat may be applied to a temperature of about 200 degrees Celsius, about 300 degrees Celsius, or about 500 degrees Celsius to about 800 degrees Celsius, 1000 degrees Celsius, or about 1200 degrees Celsius.

Disorder may be determined through an X-Ray Diffraction (XRD) pattern that decreases with increasing disorder in the material. XRD may be analyzed by a Rigaku Miniflex X-ray diffractometer instrument. In the XRD, a 311 peak (i.e., generally a peak at 36-36.6) may be associated with the spinel peak. A 400 peak (i.e., generally a peak at 40-44.6) may be associated with a disordered rock salt peak. By analyzing the full width at half maximum (FWHM) under each curve, a spinel crystal structure to rock salt ratio can be determined. Where the ratio is 0.810 or less, 0.800 or less, or 0.790 or less, and suitable bi-metals are substituted into the spinel crystal structure, the cathode material may be sufficiently disordered to reduce or eliminate the two-phase transition during battery cycling.

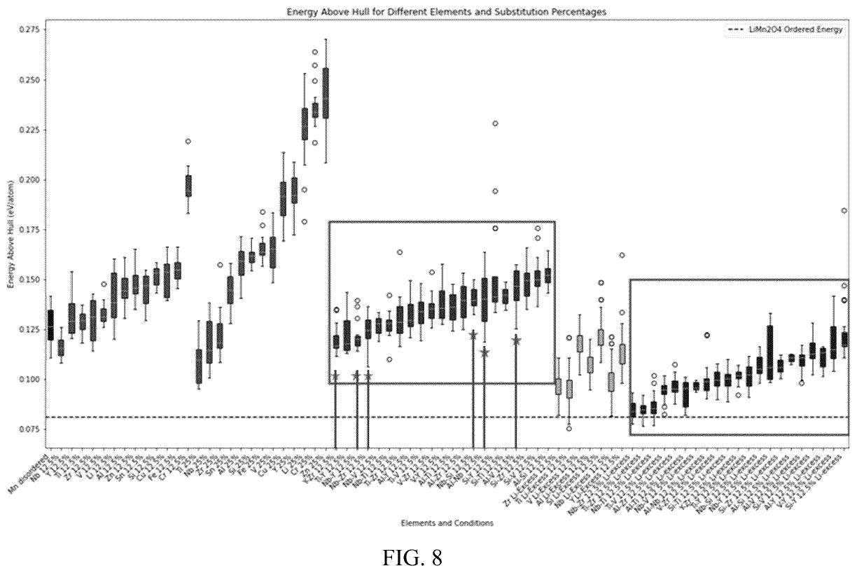

The degree that the cathode material is disordered may be determined by energy above hull for a certain substitution amount within the LMO spinel crystal structure. A lower energy above hull may indicate a greater likelihood of manganese disorder in a substituted LMO structure. The bi-element substituted LMO may include any amount of substituted metals (i.e., A and B) in the LiMnABO sufficient to achieve a lower energy above hull for the disordered LMO structure. By percentage, the substituted LiMnABO may include a metal other than manganese about 10%, 12.5%, or 15% to about 22.5%, 25%, or 27.5%. The substituted LMO formula may have an energy above hull of about 0.150 or less, about 0.140 or less, about 0.130 or less, about 0.120 or less, about 0.110 or less, or about 0.100 or less. Energy above hull may be calculated by known computational methods and experimental techniques. FIG. 8 illustrates computation results of different single and bi-element substitutions. A lower value indicates a greater likelihood of disorder. As illustrated, the bi-element substitutions generally result in lower energies above hull compared to single element substitutions, which may also be influenced by over lithiation (see right side of FIG. 8). The substituted LMO formula may include an excess of lithium such that the over lithiated substituted disordered LMO has a lower energy above hull and, without being bound by any theory, lithium ions may fill voids of the displaced Mn ions. When the cathode material is over lithiated, the chemical composition of the cathode contains more lithium ions than the stoichiometrically ideal amount, essentially providing a larger reservoir of lithium ions that can be extracted during discharge, potentially leading to a higher capacity battery compared to a standard cathode with the exact stoichiometric ratio of elements. As shown in FIG. 8, the over lithiated bi-element substitutes result in the lowest energies above hull, indicating a higher level of disorder.

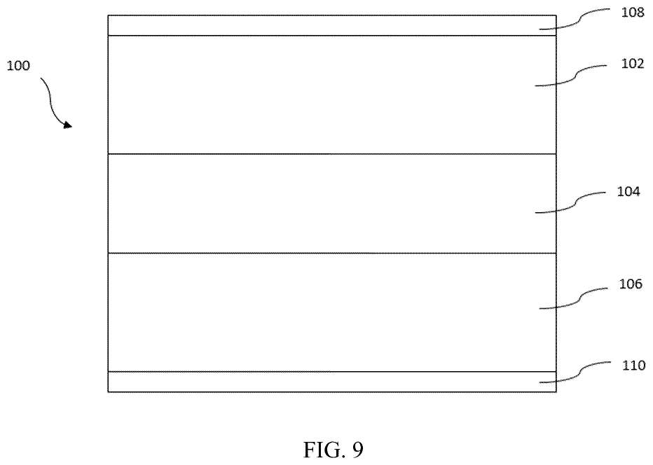

An electrochemical cell 100 is illustrated schematically in cross-section in FIG. 9. The electrochemical cell 100 of FIG. 9 is configured as a layered battery cell that includes as active layers a cathode active material layer 102 having the cathode material with the disordered spinel crystal structures as described herein, an electrolyte 104, and an anode active material layer 106. In some embodiments, such as lithium batteries using a liquid or gel electrolyte, the electrochemical cell 100 may include a separator interposed between the cathode active material layer 102 and the anode active material layer 106. In addition to the active layers, a cathode of the electrochemical cell 100 of FIG. 9 may include a cathode current collector 108 and an anode may include an anode current collector 110, configured such that the active layers are interposed between the anode current collector 110 and the cathode current collector 108. In such a configuration, the cathode current collector 108 is adjacent to the cathode active material layer 102, and the anode current collector 110 is adjacent to the anode active material layer 106. A battery can be comprised of multiple electrochemical cells 100.

The anode active material in the anode active material layer 106 of a lithium metal battery can be a layer of elemental lithium metal, a layer of a lithium compound(s) or a layer of doped lithium. The anode active material in the anode active material layer 106 of a lithium-ion battery can be a layer graphite or a silicon-based material. In some embodiments, the disordered cathode materials may be used in an anode free battery where the anode layer is formed during charging form the lithium contained in the cathode. Other anode active materials known to those skilled in the art can be used. The anode current collector 110 can be, as a non-limiting example, a sheet or foil of copper, nickel, a copper-nickel alloy, carbon paper, or graphene paper.

In lithium batteries, the electrolyte 104 may include a liquid electrolyte, a polymer ionic liquid, a gel electrolyte, or a combination thereof. The electrolyte can be an ionic liquid-based electrolyte mixed with a lithium salt. The ionic liquid may be, for example, at least one selected from N-Propyl-N-methylpyrrolidinium bis(flurosulfonyl)imide, N-methyl-N-propylpyrrolidinium bis(trifluoromethanesulfonyl)imide, N-butyl-N-methylpyrrolidinium bis(trifluoromethylsulfonyl)imide, 1-butyl-3-methylimidazolium bis(trifluoromethylsulfonyl)imide, and 1-ethyl-3-methylimidazolium bis(trifluoromethylsulfonyl)imide. The salt can be or include, for example, a fluorosulfonyl (FS0) group, e.g., lithium bisfluorosulfonylimide (LiN(FS0₂)₂, (LiFSI), LiN(FS0₂)₂, LiN(FS0₂) (CF₃S0₂), LiN(FS0₂)(C₂F₅S0₂) . In some embodiments, the electrolyte is or includes a cyclic carbonate (e.g., ethylene carbonate (EC) or propylene carbonate, a cyclic ether such as tetrahydrofuran (THF) or tetrahydropyran (TH), a glyme such as dimethoxyethane (DME) or diethoxyethane, an ether such as diethylether (DEE) or methylbutylether (MBE), their derivatives, and any combinations and mixtures thereof. Where a separator is used, such as with a liquid or gel electrolyte, the separator can be a polyolefine or a polyethylene, as non-limiting examples.

In an all-solid-state battery (ASSB), the electrolyte 104 is solid. The solid electrolyte can be, as non-limiting examples, sulfide compounds (e.g. Argyrodite, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO).

The cathode current collector 108 can be, as non-limiting examples, an aluminum sheet or foil, carbon paper or graphene paper.

### EXAMPLES

The following examples are illustrative of some of the inventive concepts of this disclosure and not meant to limit the scope of the claims.

### Synthesis of Materials

The cathode materials having the following formula may be formulated through the following techniques:

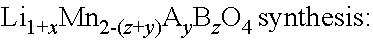

where x, y, and z are defined herein and by the following experimental setup.

The synthesis of substituted lithium manganese spinel is performed via the thermal decomposition of a sol-gel precursor. The synthesis of a Zr—Nb substituted sample (LiMn_{1.75}Zr_{0.125}Nb_{0.125}O₄) is described as follows. First, 20 mmol of lithium acetate (1.32 g), 35 mmol manganese(II) acetate (8.578 g), and 30 mmol of citric acid (5.76 g) is dissolved in 150 mL of deionized water in a 500 mL beaker. Next, 2.5 mmol (0.82 g) of zirconium(IV) isopropoxide and 2.5 mmol (0.80 g) of niobium ethoxide dissolved in 50 mL of isopropanol is added to the beaker, and the mixture is ultrasonicated, stirred and a heated at 80° C. for 1 hr. The resulting liquid mixture is subsequently dried under vacuum at 80° C. to remove the remaining solvents and form the finished sol-gel precursor. The sol-gel precursor is then ground in a mortar and pestle and heated in a furnace to between 300° C. and 800° C. for up to 4 hours to form the LiMn_{1.75}Zr_{0.125}Nb_{0.125}O₄ active material. Other substituted samples are prepared following a similar procedure, where the 2.5 mmol of zirconium(IV) isopropoxide and/or the 2.5 mmol of niobium ethoxide are replaced by 2.5 mmol of a different precursor, corresponding to the element to be substituted. In the case of niobium, niobium(V) ethoxide is used; in the case of aluminum, aluminum isopropoxide is used; in the case of iron, iron(III) nitrate is used; in the case of copper, copper(II) acetate is used; in the case of yttrium, yttrium(III) acetate is used; in the case of vanadium, vanadium(V) oxytriisopropoxide is used; in the case of silicon, tetraethoxysilane is used; in the case of titanium, titanium(IV) isopropoxide is used; and in the case of the non-substituted LiMn₂O₄ the amount of manganese(II) acetate is increased to 35 mmol. The degree of substitution is adjusted by varying the amounts of manganese(II) acetate and the substituent element precursors, and in all cases the sum of both compounds should equal 40 mmol.

### Electrochemical Testing

In order to perform electrochemical tests on the Li₁₊ₓMn_{2-(z+y)}A_{y}B_{z}O₄ active materials in a lithium-ion battery cell, the Li₁₊ₓMn_{2-(z+y)}A_{y}B_{z}O₄ active materials are first fabricated into a battery cathodes using a slurry coating method. The as-synthesized active material is mixed with a conductive carbon (i.e. acetylene black) and a polyvinylidene fluoride binder in a 8:1:1 ratio by mass, followed the addition of N-methyl-2-pyrrolidone solvent to form a viscous slurry. The slurry is then mechanically mixed until uniform and cast onto an aluminum foil current collector using a blade coating machine (doctor blade). The resulting coated foils are then dried under flowing air for up to 12 hrs, before being further dried under vacuum at 80° C. for 2 hrs to yield the finished cathodes.

The as-prepared cathodes are then cut into 1 cm diameter discs and assembled into a 2032 coin-type cell using a metallic lithium foil as the anode, a 1 M solution of lithium hexafluorophosphate (LiPF₆) in a mixture of ethylene carbonate, and dimethyl carbonate as the electrolyte, and a porous glass fiber sheet as the separator. The resulting test cells are then subject to constant current charge/discharge tests using a Biologic VMP-3 potentiostat with a constant current of C/20. Results are shown in FIGS. 1-7. The FIGS. 2-7 illustrate that bi-element substitution of specific metals in the LMO crystal structure reduce the sharp two-phase transition during cycling, as shown by the 3.9-2.9 V Cap increase above 6%. On the other hand, FIG. 1 illustrates performance of unsubstituted LMO.

### Structural Characterization

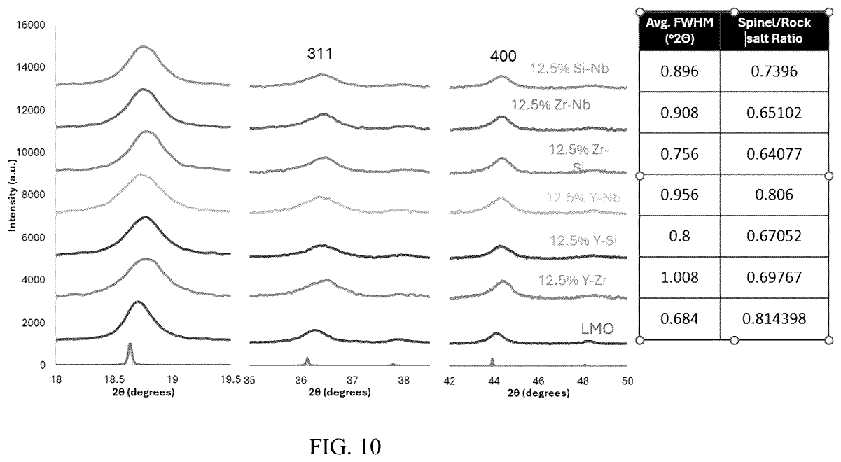

X-ray diffraction patterns of the as-synthesized cathode active materials are collected using a Rigaku Miniflex X-ray diffractometer. Samples are prepared by placing the assynthesized powder onto a low-background silicon sample holder. The diffraction pattern is measured using Cu kα radiation from 10-90 °2θ (2-theta) at a scan rate of 3°2θ per second. Results are shown in FIG. 10. As seen from FIG. 10, compositions with high disorder can be determined by a desirable spinel/rock salt peak ratio, such as below 0.810, compared to the LMO X-ray diffraction pattern.

Unless otherwise defined, all technical and scientific terms used have the same meaning as commonly understood by one of ordinary skill in the art to which the claimed subject matter belongs. The terminology used in this description is for describing particular embodiments only and is not intended to be limiting. As used in the specification and appended claims, the singular forms “a,” “an,” and “the” are intended to include the plural forms as well, unless the context clearly indicates otherwise.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A cathode material for an electrochemical cell, comprising:
a cation disordered composition comprising a spinel crystal structure and a formula: 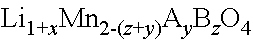
wherein 0.0≤x≤0.25, 0.01≤y≤0.49, 0.01≤z≤0.49, 0.02≤y+z≤0.5, and A and B are different and independently selected from Y, Zr, Si, V, Nb, Fe, Cu, Ti, and Al.

2. The cathode material of claim 1, having a cell potential in a lithium-ion battery cell that exhibits a gradual voltage change, wherein a percentage of total capacity (mAh/g) observed between 3.9 V and 2.9 V vs. Li+/Li is at least 6%.

3. The cathode material of claim 1, wherein A is Y and B is Zr.

4. The cathode material of claim 3, having the formula:

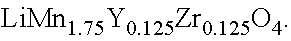

5. The cathode material of claim 4, having a cell potential in a lithium-ion battery cell that exhibits a gradual voltage change, wherein a percentage of total capacity (mAh/g) observed between 3.9 V and 2.9 V vs. Li+/Li is at least 9%.

6. The cathode material of claim 1, wherein A is Zr and B is Nb.

7. The cathode material of claim 6, having the formula:

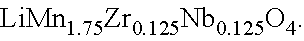

8. The cathode material of claim 7, having a cell potential in a lithium-ion battery cell that exhibits a gradual voltage change, wherein a percentage of total capacity (mAh/g) observed between 3.9 V and 2.9 V vs. Li+/Li is at least 8%.

9. The cathode material of claim 1, wherein A is one of Y or Zr and B is Si.

10. The cathode material of claim 1, wherein A is one of Y or Si and B is Nb.

11. A cathode material for an electrochemical cell, comprising:
a cation disordered composition comprising a spinel crystal structure and a formula: 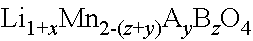
wherein 0.0≤x≤0.25, 0.01≤y≤0.49, 0.01≤z≤0.49, 0.02≤y+z≤0.5, A and B are different and independently selected from Y, Zr, Si, V, Nb, Fe, Cu, Ti, and Al, and
wherein the cation disordered composition has a cell potential in a lithium-ion battery cell that exhibits a gradual voltage change, wherein a percentage of total capacity observed between 3.9 and 2.9 V vs. Li+/Li is at least 6%.

12. An electrochemical cell, comprising:
an anode;
an electrolyte; and
a cathode comprising a cathode material with a formula: 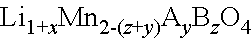
wherein 0.0≤x≤0.25, 0.01≤y≤0.49, 0.01≤z≤0.49, 0.02≤y+z≤0.5, A and B are different and independently selected from Y, Zr, Si, V, Nb, Fe, Cu, Ti, and Al.

13. The electrochemical cell of claim 12, being a lithium-ion battery cell, wherein the cathode material has a cell potential in the lithium-ion battery cell that exhibits a gradual voltage change, wherein a percentage of total capacity (mAh/g) observed between 3.9 V and 2.9 V vs. Li+/Li is at least 6%.

14. The electrochemical cell of claim 12, wherein A is Y and B is Zr.

15. The electrochemical cell of claim 14, wherein the cathode material has the formula:

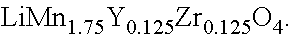

16. The electrochemical cell of claim 15, being a lithium-ion battery cell and the cathode material has a cell potential in the lithium-ion battery cell that exhibits a gradual voltage change, wherein a percentage of total capacity (mAh/g) observed between 3.9 V and 2.9 V vs. Li+/Li is at least 9%.

17. The electrochemical cell of claim 12, wherein A is Zr and B is Nb.

18. The electrochemical cell of claim 17, wherein the cathode material has the formula:

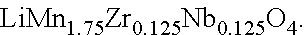

19. The electrochemical cell of claim 18, being a lithium-ion battery cell, the cathode material having a cell potential in a lithium-ion battery cell that exhibits a gradual voltage change, wherein a percentage of total capacity (mAh/g) observed between 3.9 V and 2.9 V vs. Li+/Li is at least 8%.

20. The electrochemical cell of claim 12, being a lithium metal battery cell.
